(19) United States
(12) Patent Application Publication
(10) Pub. No.: US 2009/0081531 A1
(43) Pub. Date: Mar. 26, 2009

(54) Piping Structure for Vehicle Battery

(76) Inventor: Takehito Yoda, Aichi-ken (JP)

Correspondence Address: KENYON & KENYON LLP, 1500 K STREET N.W., SUITE 700, WASHINGTON, DC, 20005, US

(21) Appl. No.: 11/886,788

(22) PCT Filed: Oct. 11, 2006
(86) PCT No.: PCT/JP2006/320694

§ 371 Date: Sep. 20, 2007

(30) Foreign Application Priority Data
Oct. 14, 2005 (JP) 2005-300650

(51) Int. Cl. H01M 2/12

(52) U.S. Cl. 429/57

(57) ABSTRACT

A piping structure for a vehicle battery has the battery attached to a hybrid vehicle to be relatively immovable with respect to the vehicle, and also has a gas discharge hose connected to the battery for guiding hydrogen gas discharged from the battery outside of the vehicle. The gas discharge hose has an inner wall defining a cavity where the hydrogen gas flows. The inner wall is formed with recesses and protrusions. By such a structure, there is provided a piping structure for a vehicle battery having the gas flow less likely to be interrupted even if external forces are applied.

### TECHNICAL FIELD

The present invention generally relates to a piping structure for a vehicle battery, and more particularly to a piping structure for a vehicle battery, including a tube from which gas generated at the battery is discharged outside of a vehicle.

### BACKGROUND ART

With reference to a conventional piping structure for a vehicle battery, for example, Japanese Patent Laying-Open No. 07-172191 discloses a battery housing structure for an electric vehicle which is aimed at preventing a battery from being submerged in water and efficiently discharging hydrogen gas outside. According to this patent document, the battery has a gas vent tube for discharging the hydrogen gas generated at the battery.

Furthermore, Japanese Patent Laying-Open No. 2004-148850 discloses a piping structure for a vehicle battery which is aimed at preventing an exhaust hose from bending to avoid closure of an internal passage. According to this patent document, the exhaust hose for discharging hydrogen gas generated during charging outside of a vehicle is connected to the upper side of the battery. The exhaust hose is formed of a rubber pipe or the like with relatively low rigidity.

Japanese Patent Laying-Open No. 2004-161058 discloses a battery cooling duct which is aimed at discharging gas produced by a battery outside of a vehicle. According to this patent document, a natural ventilation duct in communication with the atmosphere outside the vehicle is connected to an intake duct through which air within the cabin is drawn into a battery pack. Furthermore, Japanese Patent Laying-Open No. 2003-123721 discloses a battery set which is aimed at reducing the number of components and firmly holding an exhaust tube. The battery set disclosed in this patent document includes the exhaust tube for exhausting gas discharged from a battery module outside a case.

Furthermore, Japanese Patent Laying-Open No. 01-292762 discloses a charging device for a storage battery which is aimed at suppressing spark generation due to a poor contact between a battery terminal and a conductor connecting part and preventing explosion or the like caused by the generated hydrogen gas. According to this patent document, a flexible hose forms an exhaust passage for discharging hydrogen gas and oxygen gas generated during charging of a monoblock-battery. The monoblock-battery is attached to a frame which can be moved in the upward and downward directions.

The patent documents described above disclose tubes and hoses for discharging gas generated at batteries outside of vehicles. When these tubes and hoses are externally compressed, however, the gas flowing outside of the vehicle may be interrupted.

### DISCLOSURE OF THE INVENTION

To solve the above-described problems, an object of the present invention is to provide a piping structure for a vehicle battery in which a gas flow is less likely to be interrupted even if external forces are applied to the piping structure.

A piping structure for a vehicle battery according to an aspect of the present invention includes a battery mounted on a vehicle, and a tube connected to the battery for guiding gas discharged from the battery outside of the vehicle. The tube has an inner wall defining a cavity where the gas flows. The inner wall is formed with recesses and protrusions.

A piping structure for a vehicle battery according to another aspect of the present invention includes a battery attached to a vehicle to be relatively immovable with respect to the vehicle, and a tube connected to the battery for guiding gas discharged from the battery outside of the vehicle. The tube has an inner wall defining a cavity where the gas flows. The inner wall is formed with recesses and protrusions.

According to a piping structure for a vehicle battery structured in the above-described manner, the inner wall of the tube is formed with recesses and protrusions. Therefore, a gap is readily ensured in the cavity at the inner side of the tube when external forces are applied to the tube. The gap ensures that interruption of a gas flow within the tube can be avoided when external forces are applied to the tube.

The tube extends along a prescribed axis from the battery to outside of the vehicle. Preferably, the cavity defined by the inner wall includes a main flow path extending along the prescribed axis and sub flow paths surrounding the main flow path.

Still preferably, the sub flow paths continuously extend in a spiral manner along the prescribed axis.

Still preferably, the tube is formed in the shape of bellows.

The battery is placed in a luggage room.

As described above, according to the present invention, a piping structure for a vehicle battery in which a gas flow is less likely to be interrupted even if external forces are applied to the piping structure can be provided.

### BRIEF DESCRIPTION OF THE DRAWINGS

FIG. 1 is a cross-sectional view of a vehicle to which a piping structure for a vehicle battery according to the embodiment of the present invention is applied.

FIG. 2 is a perspective view of a battery pack mounted on the vehicle shown in FIG. 1.

FIG. 3 is a side view of a part of a gas discharge hose shown in FIG. 2.

FIG. 4 is a cross-sectional view of the gas discharge hose taken along the line IV-IV shown in FIG. 3.

FIG. 5 is a cross-sectional view of the gas discharge hose taken along the line V-V shown in FIG. 3.

FIG. 6 is a cross-sectional view of the gas discharge hose shown in FIG. 4, to which external forces are applied.

FIG. 7 is a side view showing a first modification of the gas discharge hose shown in FIG. 2.

FIG. 8 is a perspective view showing a second modification of the gas discharge hose shown in FIG. 2.

FIG. 9 is a perspective view showing a third modification of the gas discharge hose shown in FIG. 2.

### BEST MODES FOR CARRYING OUT THE INVENTION

The embodiments of the present invention will be described with reference to the accompanying drawings. It should be noted that the same or corresponding components are represented by the same reference numerals in the drawings referenced below.

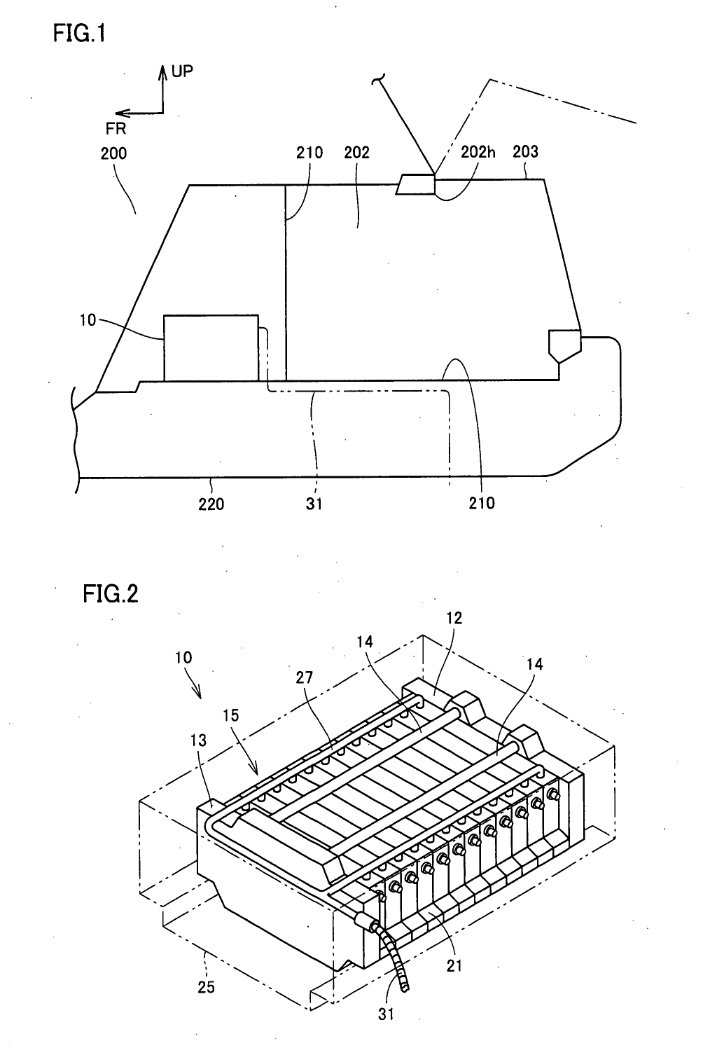

FIG. 1 is a cross-sectional view of a vehicle to which a piping structure for a vehicle battery according to the embodiment of the present invention is applied. FIG. 1 shows a cross section of a luggage room located at the back of the vehicle. The vehicle shown in FIG. 1 is a hybrid vehicle powered by an internal combustion engine such as a gasoline engine, a diesel engine or the like, as well as a secondary battery which is chargeable and dischargeable.

Referring to FIG. 1, the hybrid vehicle includes a vehicle cabin 200 and a luggage room 202 located at the back of the vehicle. Luggage room 202 is formed in a cavity surrounded by a trim 210. To the rear end of the hybrid vehicle, a luggage room door 203 which can be opened and closed freely is provided. When luggage room door 203 is opened, the rear of the vehicle opens to form an opening 202h. Through opening 202h, luggage can be loaded into and out from luggage room 202. A battery pack 10 is placed in the cavity in front of luggage room 202.

FIG. 2 is a perspective view of a battery pack mounted on the vehicle shown in FIG. 1. Referring to FIGS. 1 and 2, battery pack 10 includes a battery 15 and a battery case 25 forming the cavity for housing battery 15. Battery 15 corresponds to a NiMH (Nickel Metal Hydride) battery.

Battery 15 is constructed of a plurality of battery modules 21 that are stacked in one direction. A battery module 21 has substantially a rectangular parallelepiped shape. Battery modules 21 are stacked in such a manner that the side having the largest area among the sides forming the contour of a battery module 21 faces the side having the largest area of an adjacent battery module 21. The plurality of battery modules 21 are electrically connected in series to one another. Restraining plates 12 and 13 are disposed on either side of the plurality of stacked battery modules 21. These plates are connected by restraining rods 14 disposed on the upper and lower sides of battery modules 21. In the above-described manner, the plurality of battery modules 21 are integrally fixed to form battery 15.

Battery 15 corresponding to a nickel metal hydride battery generates hydrogen gas in overcharging and over discharging. Battery pack 10 additionally includes a gas discharge hose 31 from which the hydrogen gas generated at battery 15 is discharged outside of the vehicle.

An exhaust pipe 27 in communication with the interior of respective battery modules 21 is connected to battery 15. Gas discharge hose 31 is connected to exhaust pipe 27. Outside battery case 25, gas discharge hose 31 extends outwards of the vehicle. Gas discharge hose 31 extends along the proximity of trim 210 to open at the bottom 220 of the hybrid vehicle.

It should be noted that battery pack 10 is not limited to being placed in luggage room. Battery pack 10 may be placed for example under the front seat or rear seat, under a center console installed between the driver's seat and passenger seat at the front seat, or the like. In the case where a vehicle has three rows of seats, battery pack 10 may be placed under the second seat or the third seat. The position where gas discharge hose 31 opens may be altered as required depending on the position where battery pack 10 is placed. Gas discharge hose 31 may be provided directly in communication with the interior of battery modules 21.

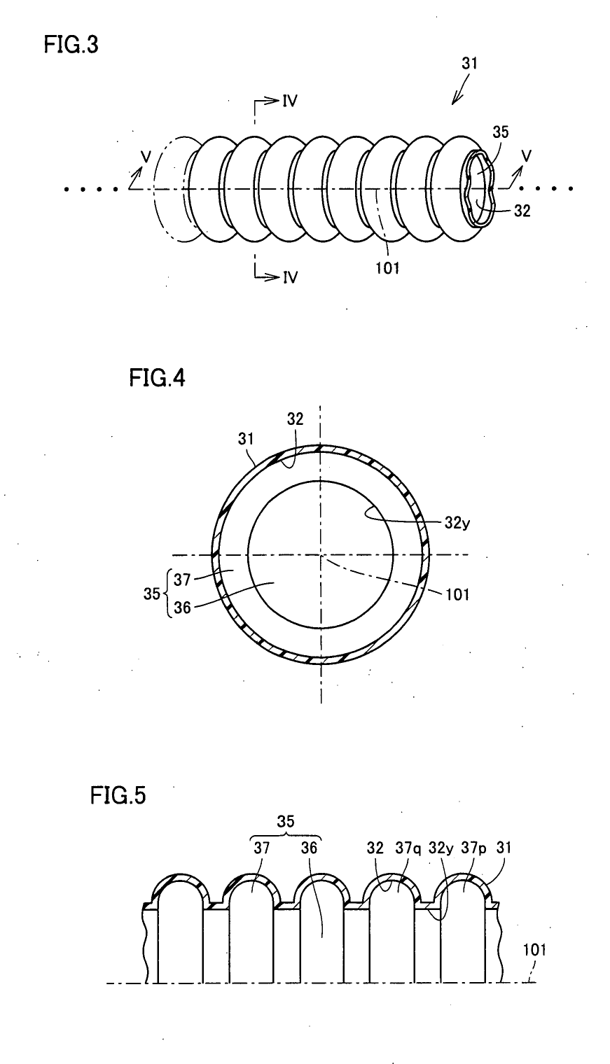

FIG. 3 is a side view of a part of a gas discharge hose shown in FIG. 2. Referring to FIG. 3, gas discharge hose 31 is formed of a conduit hose having the shape of bellows. Gas discharge hose 31 extends along an axis 101. Gas discharge hose 31 is cylindrically formed about axis 101.

Gas discharge hose 31 is made of resin material, for example polypropylene. Gas discharge hose 31 is formed in a bendable manner, so it can freely change its direction in which it extends along axis 101. Gas discharge hose 31 is not limited to being made of resin material. It may be made of for example metal. It may be made of elastic members.

Gas discharge hose 31 has an inner wall 32. The area surrounded by inner wall 32 forms a cavity 35 where hydrogen gas generated at battery modules 21 flows. Inner wall 32 is formed with recesses and protrusions.

The recesses and protrusions formed on inner wall 32 are sized to be visually perceivable. For example, the difference in height between the recesses and the protrusions formed on inner wall 32 is greater than or equal to 1/20 of the radius of inner wall 32. The difference in height between the recesses and the protrusions is greater than or equal to 1/10 of the radius of inner wall 32. The difference in height between the recesses and the protrusions is greater than or equal to ⅕ of the radius of inner wall 32. The difference in height between the recesses and the protrusions is smaller than or equal to ½ of the radius of inner wall 32. The difference in height between the recesses and the protrusions is smaller than or equal to ¼ of the radius of inner wall 32.

FIG. 4 is a cross-sectional view of the gas discharge hose taken along the line IV-IV shown in FIG. 3. FIG. 5 is a cross-sectional view of the gas discharge hose taken along the line V-V shown in FIG. 3.

Referring to FIGS. 4 and 5, cavity 35 defines a main flow path 36 extending along axis 101 and sub flow paths 37 extending annularly about axis 101 along the circumference of main flow path 36. Main flow path 36 continuously extends in the direction of axis 101. A plurality of sub flow paths 37 are formed with a prescribed spacing in the direction of axis 101. Adjacent sub flow paths 37p and 37q are not connected to each other. Main flow path 36 is formed more inwardly than a reduced-diameter portion 32y where the diameter is the smallest in inner wall 32. Sub flow paths 37 are formed more outwardly than reduced-diameter portion 32y.

It should be noted that sub flow paths 37 may be continuously arranged side by side in the direction of axis 101 without being spaced apart in the direction of axis 101.

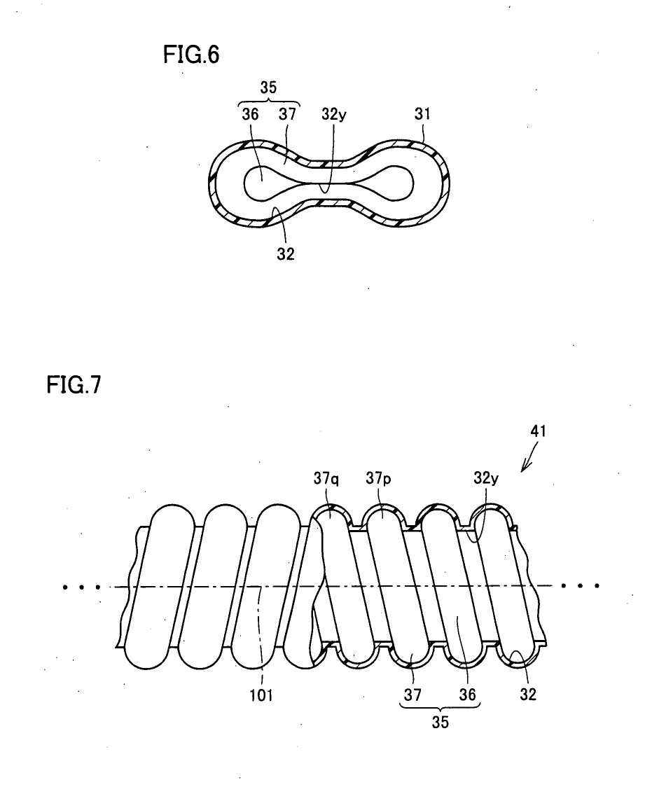

FIG. 6 is a cross-sectional view of the gas discharge hose shown in FIG. 4, to which external forces are applied. Referring to FIG. 6, it is assumed that external forces may be applied to gas discharge hose 31 such as in the case where gas discharge hose 31 is compressed by trim 210 when luggage is packed into luggage room 202.

With gas discharge hose 31 of the present embodiment, however, inner wall 32 is formed with recesses and protrusions. Thus, as shown in FIG. 6, even if gas discharge hose 31 becomes deformed such that inner wall 32 is pressed together to form contact at reduced-diameter portion 32y, gas discharge hose 31 is less likely to become deformed any further. Therefore, sub flow paths 37 qualified as the recesses at inner wall 32 are maintained as flow paths of hydrogen gas. Furthermore, gas discharge hose 31 formed in the shape of bellows is less likely to become deformed by external forces since strength in the radial direction increases.

A piping structure for a vehicle battery according to the embodiment of the present invention includes a battery 15 mounted on a hybrid vehicle qualified as a vehicle, and also includes a gas discharge hose 31 qualified as a tube which is connected to battery 15 for guiding hydrogen gas qualified as the gas discharged from battery 15 outside of the vehicle. Gas discharge hose 31 has an inner wall 32 defining a cavity 35 where hydrogen gas flows. Inner wall 32 is formed with recesses and protrusions.

A piping structure for a vehicle battery has a battery 15 attached to a hybrid vehicle to be relatively immovable with respect to the vehicle, and also has a gas discharge hose 31 connected to battery 15 for guiding hydrogen gas discharged from battery 15 outside of the vehicle. Gas discharge hose 31 has an inner wall 32 defining a cavity 35 where hydrogen gas flows. Inner wall 32 is formed with recesses and protrusions.

With the piping structure for the vehicle battery according to the embodiment of the present invention which is structured in the above-described manner, cavity 35 within gas discharge hose 31 to which external forces are applied is not easily blocked. Therefore, hydrogen gas generated at battery 15 can be discharged outside of the vehicle more reliably. According to the present embodiment, instead of adding a protecting member to prevent gas discharge hose 31 from receiving external forces, gas discharge hose 31 itself is formed in the shape to avoid blockage. Therefore, the present embodiment can offer additional advantages, such as reduction of the number of components and improvement in the workability in attachment of the hose, at the same time.

FIG. 7 is a side view showing a first modification of the gas discharge hose shown in FIG. 2. FIG. 7 shows a cross section of a portion of the gas discharge hose. Referring to FIG. 7, a gas discharge hose 41 of the present modification has sub flow paths 37 continuously extending in a spiral manner in the direction of axis 101. Adjacent sub flow paths 37p and 37q are connected to each other. In this case, even if main flow path 36 is completely blocked when external forces are applied to gas discharge hose 41, hydrogen gas is discharged through sub flow paths 37 outside of the vehicle.

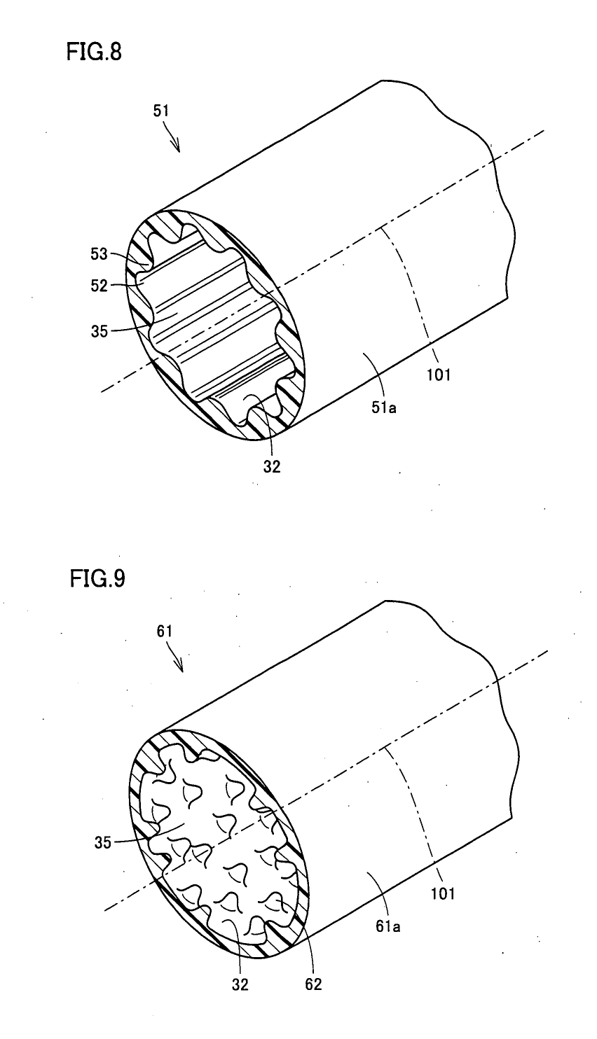

FIG. 8 is a perspective view showing a second modification of the gas discharge hose shown in FIG. 2. FIG. 8 and FIG. 9 of which description will be provided afterwards represent cutaway cross sections of the gas discharge hose. Referring to FIG. 8, a gas discharge hose 51 of the present modification is formed with grooves 52 and projections 53 on inner wall 32. A plurality of grooves 52 and projections 53 are circumferentially arranged side by side about axis 101 in an alternating manner. Grooves 52 and projections 53 extend along axis 101. The outer circumferential surface 51a of gas discharge hose 51 is formed smoothly. In other words, the outer circumferential surface 51a does not have the shape with recesses and protrusions.

FIG. 9 is a perspective view showing a third modification of the gas discharge hose shown in FIG. 2. Referring to FIG. 9, a gas discharge hose 61 of the present modification has a plurality of protrusions 62 projecting from inner wall 32. The plurality of protrusions 62 are spaced apart from one another and randomly scattered on the surface of inner wall 32. The outer circumferential surface 61a of gas discharge hose 61 is formed smoothly. In other words, the outer circumferential surface 61a does not have the shape with recesses and protrusions.

The modifications described with reference to FIGS. 7-9 can also offer the same advantages as those obtained by the embodiment described above.

Although the present embodiment has been described based on a nickel metal hydride battery as the battery, the present invention is not limited thereto. Any battery may be used if it is assumed that gas is generated during usage thereof. For example, the battery may be a lithium-ion battery.

Further, in the present embodiment, a piping structure for a vehicle battery according to the present invention is applied to a hybrid vehicle powered by an internal combustion engine and a secondary battery. The present invention, however, is also applicable to a FCHV (Fuel Cell Hybrid Vehicle) powered by a fuel cell and a secondary battery, or an EV (Electric Vehicle). In the hybrid vehicle of the present embodiment, an internal combustion engine is driven at an operating point of optimum fuel efficiency, whereas, in the FCHV, a fuel cell is driven at an operating point of optimum electric power generation efficiency. A secondary battery is used in both hybrid vehicles in basically the same manner.

It should be understood that the embodiments disclosed herein are illustrative and not limitative in any respect. The scope of the present invention is defined by the terms of the claims, rather than the embodiments and examples above, and is intended to include any modifications within the scope and meaning equivalent to the terms of the claims.

### INDUSTRIAL APPLICABILITY

The present invention is mainly applied to a piping structure for a nickel metal hydride battery mounted on a hybrid vehicle as a power source.

1. A piping structure for a vehicle battery comprising:
a battery attached to a vehicle to be relatively immovable with respect to the vehicle; and
a tube connected to said battery for guiding gas discharged from said battery outside of the vehicle,
said tube having an inner wall defining a cavity where the gas flows, and
said inner wall being formed with recesses and protrusions.

2. The piping structure for a vehicle battery according to claim 1, wherein
said tube extends along a prescribed axis from said battery outwards of the vehicle, and
said cavity defined by said inner wall includes a main flow path extending along said prescribed axis and sub flow paths surrounding said main flow path.

3. The piping structure for a vehicle battery according to claim 2, wherein
said sub flow paths continuously extend in a spiral manner along said prescribed axis.

4. The piping structure for a vehicle battery according to claim 1, wherein
said tube is formed in the shape of bellows.

5. The piping structure for a vehicle battery according to claim 1, wherein
said battery is placed in a luggage room.
